(19) United States
(12) Patent Application Publication
(10) Pub. No.: US 2007/0281822 A1
(43) Pub. Date: Dec. 6, 2007

(54) Electric hand tool device

(75) Inventors: Christoph Maier, Notzingen (DE); Martin Baumann, Esslingen (DE)

Correspondence Address: DREISS, FUHLENDORF, STEIMLE & BECKER, POSTFACH 10 37 62, D-70032 STUTTGART, omitted

(73) Assignee: Metabowerke GmbH, Nuertingen (DE)

(21) Appl. No.: 11/802,935

(22) Filed: May 29, 2007

(30) Foreign Application Priority Data
Jun. 1, 2006 (DE) 102006025538.0-15

(51) Int. Cl. F16H 3/44

(52) U.S. Cl. 475/286

(57) ABSTRACT

The invention concerns an electric hand tool device comprising a drive motor and a driven shaft (36) for driving an electric tool, wherein a switchable planetary gear comprising two gear stages (12, 14) is provided between the drive motor and the driven shaft (36), wherein each gear stage (12, 14) comprises a ring gear (20, 22) with an inner toothing, and a sun wheel (16, 18) with an outer toothing for driving the gear, with which the planet wheels (30, 32) of the respective gear stage (12, 14) mesh, wherein the outer diameters of the sun wheels (16, 18) and the inner diameters of the ring gears (20, 22) of the two gear stages (12, 14) are different, the planet wheels (30, 32) of a gear stage (12, 14) each being held on one respective planet carrier (26, 28), and the output is realized via the planet carrier (28) of a gear stage (12), wherein the ring gears (20, 22) of the gear stages (12, 14) are connected to each other such that they cannot rotate relative to each other, and a switching means (38′) is in locking engagement with the ring gears (20, 22) in a first switching stage to block them, wherein, in a second switching stage, the planet carrier (26) which is not used for output is blocked by locking engagement with a switching means (38).

This application claims Paris Convention priority of DE 10 2006 025 538.0 filed Jun. 1, 2006 the complete disclosure of which is hereby incorporated by reference.

### BACKGROUND OF THE INVENTION

The invention concerns an electric hand tool device comprising a drive motor and a driven shaft for driving an electric tool, wherein a switchable planetary gear, disposed between the drive motor and the driven shaft, comprises two gear stages, each gear stage comprising a ring gear having an inner toothing and a sun wheel having an outer toothing for driving the gear, with which the planet wheels of the respective gear stage mesh, wherein the outer diameters of the sun wheels and the inner diameters of the ring gears of the two gear stages differ.

Planetary gears are conventionally used in electric hand tool devices. DE 199 02 187 A1 discloses e.g. a planetary gear with switchable gears for electric hand tool devices such as e.g. screwdrivers, wherein an axially displaceable ring gear, which is part of the second planetary stage, is provided for switching gears, wherein three planetary stages are preferably provided.

DE 197 54 165 A1 discloses an electric hand tool device, i.e. an electric turning tool, in particular an electric cordless screwdriver, wherein a planetary gear that switches in dependence on the torque has two switching stages, each switching stage having its own outer, rotatable ring gear. One ring gear of one of the two switching stages is lockingly engaged for switching from one switching stage to the other switching stage.

The above-mentioned designs are disadvantageous in that the mechanisms for changing the switching stages are complex, thereby increasing wear.

It is therefore the underlying purpose of the invention to provide an electric hand tool device with a planetary gear which requires only little axial space and provides a simple change mechanism between the switching stages.

### SUMMARY OF THE INVENTION

This object is achieved in accordance with the invention by an electric hand tool device of this type, wherein the planet wheels of a gear stage are each held on one planet support, the output being realized via the planet carrier of a gear stage, wherein the ring gears of the gear stages are connected such that they cannot rotate relative to each other and, in a first switching stage, a switching means is in locking engagement with the ring gears, thereby blocking them, and in a second switching stage, the planet carrier which is not used for the output is blocked by locking engagement of a switching means.

A gear of this type produces a relatively simple output and switching arrangement which increases the switching comfort and prolongs the service life. In the present inventive arrangement, all toothed wheels are in permanent engagement, which also reduces wear.

In accordance with the invention, the ring gears of the two gear stages are connected to each other such that they cannot rotate relative to each other. This may be, in particular, a double ring gear, wherein the ring gear of the gear stage used for the output may have a smaller diameter than the ring gear of the other gear stage. The sun wheel may accordingly also have a smaller outer diameter in the area of the gear stage used for the output than the sun wheel in the area of the other gear stage. The ratio of dimensions thereby depends on the desired transmission ratio.

If, in a first switching process, the interconnected ring gears are blocked, the planet carrier of the switching stage, which is not used for the output, can freely rotate. The same also applies for the planet wheels of the planetary stage used for the output, which, in turn, rotates the planet carrier of the corresponding gear stage such that it drives the driven shaft at high speed.

In contrast thereto, the planet carrier of the planetary stage, which is not used for the output, is blocked in slow gear, and the ring gears of the two gear stages, which are connected to each other such that they cannot rotate relative to each other, can rotate. At this gear stage, the ring gear is driven in a direction of rotation which is opposite to that of the sun wheels.

This results in a different speed of rotation or rolling of the planets of the planetary stage used for the output, and therefore in a different speed of rotation of the planet carrier of this planetary stage. The driving speed of the driven shaft and thus also of an electric hand tool device which is coupled therewith is thereby reduced.

In accordance with a first embodiment, the sun wheels may be coupled to each other such that they cannot rotate relative to each other. The sun wheels may thereby also be preferably connected to each other in one piece.

Moreover, the switching means for switching the gear stages can be axially shifted from one switching stage to the next, for engagement and release. One or more switching rings may thereby be provided as switching means, wherein, in particular, the switching means that block the planet carrier and the switching means that block the ring gear are coupled to each other in one piece and are combined, in particular, in one single switching ring. This switching ring may then be provided between the gear and a gear housing receiving the gear.

The electric hand tool device is preferably a screwdriver with a corresponding integrated gear.

The invention is explained in more detail below with reference to the drawing.

### BRIEF DESCRIPTION OF THE DRAWING

FIG. 1 shows a schematic longitudinal section through the gear; and

FIGS. 2 a) and b) are schematic detailed views of the gear positions in the respective switching stages

### DESCRIPTION OF THE PREFERRED EMBODIMENT

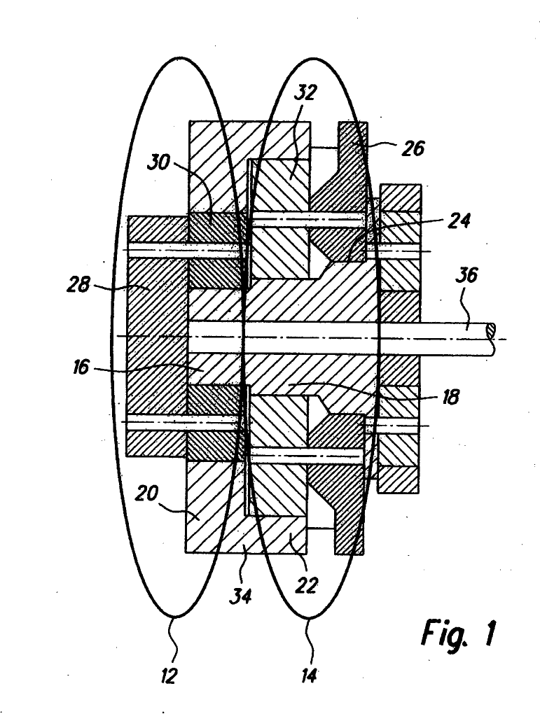

FIG. 1 shows a schematic view of a gear that can be used in an inventive electric hand tool device. The gear has two gear stages, designated with reference numerals 12 and 14. Each of the gear stages comprises a sun wheel 16, 18 and a ring gear 20, 22. The sun wheels 16 and 18 are connected to each other in one piece. The sun wheel 18 has a larger outer diameter in the area of the gear stage 14 than the sun wheel 16 in the area of the other gear stage 12. The sun wheel moreover has a third diameter 24 in the area of which a planet carrier 26 of the gear stage 14 circulates on the sun wheel. The output, i.e. the drive of a driven shaft, is thereby realized via a planet carrier 28 of the gear stage 12. Each planet carrier 26 and 28 has associated planets 30, 32 which have an outer toothing and are in permanent engagement with the outer toothing of the sun wheels 18 and 16 and the inner toothing of the ring gears 20 and 22. The ring gears 20 and 22 are thereby connected to each other such that they cannot rotate relative to each other and are produced in one piece, i.e. a double ring gear 34. If the drive is realized via a drive shaft 36 which is connected to a drive motor (not shown), the planets 30 and 32 of the gear stages are rotated, wherein the planets rotate in a direction opposite to the sun wheels 16 and 18.

The drive shaft 36 moreover acts on a third gear stage 37 which contains a torque coupling 39.

In a first slow switching stage, the planet carrier 26 of the gear stage 14 is blocked, wherein the double ring gear 34 freely rotates. The double ring gear 34 thereby also rotates in the opposite direction of the sun wheels 16 and 18. The resulting transmission ratio produces slow revolution of the planets 30 in the double ring gear 34, thereby reducing the rotational speed of the planet carrier 28.

In a second fast switching stage, the double ring gear 34 is blocked by a switching ring which can be axially displaced and is either in locking engagement with the planet carrier 26 or the double ring gear 34. The planet carrier 26 can freely rotate in this fast switching stage. This results moreover in another planet carrier 28 transmission ratio and thereby in a faster electric hand tool device drive.

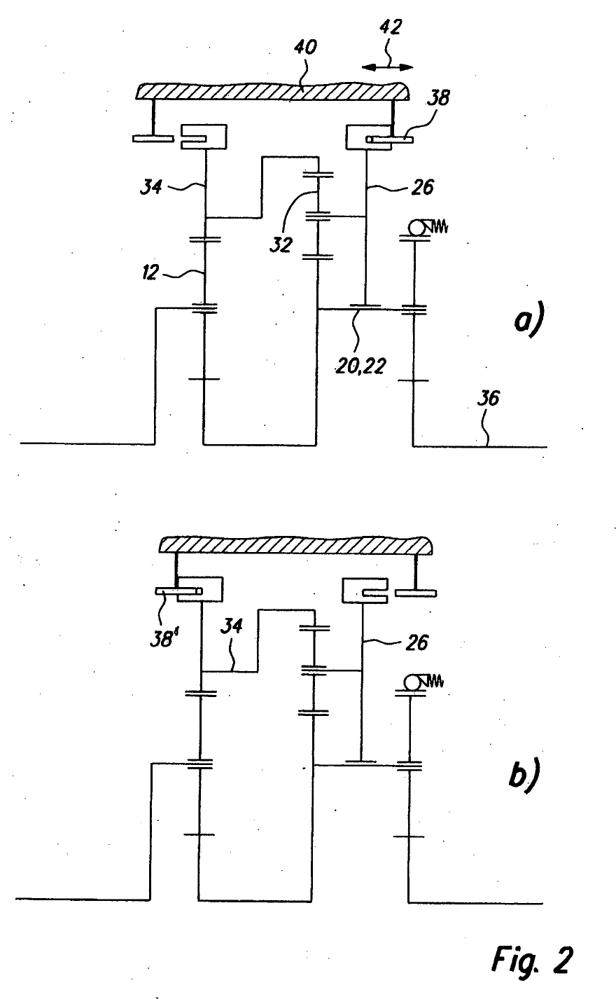

FIGS. 2a) and b) show the respective gear positions. The same elements have the same reference numerals as in FIG. 1. A sun wheel, designated with 16, 18 herein, is driven by the drive. A planet carrier 26 of a gear stage 14 rotates about the sun wheel. The planet carrier is blocked in FIG. 2a) by a switching means 38. The switching means 38 which is fixed to a switching ring 40 can thereby be axially displaced in the direction of arrow 42. First planet wheels 32 are coupled to the planet carrier 26, which mesh with a double ring gear 34. A second gear stage is moreover in rotary contact with an output via planet wheels 30 and a planet carrier 26. When the first planet carrier is blocked, the planets 32 only revolve around themselves and not around the ring gear. This drives the double ring gear 34 such that the second planetary stage 12 is influenced by the rotation of the sun wheel and also by the rotation of the double ring gear 34, thereby producing the driven speed on the output shaft of the planet carrier 28.

FIG. 2b) shows the second switching stage with blocked double ring gear 34, wherein a switching means 38′ is in contact with the double ring gear 34. The planet carrier 26 can then freely rotate. The planets of the gear stage 12 revolve in the stationary ring gear with a different speed, thereby providing a different driven speed.

Further advantages and features of the invention can be extracted from the claims and the drawing. The present invention provides a gear that requires little axial space and moreover can be operated with little wear through permanent engagement of all toothed wheels.

We claim:

1. An electric hand tool device having a motor driving a drive shaft, the device comprising:
a first sun wheel, said first sun wheel having a first outer diameter;
a first planet carrier;
a first planet wheel in meshed engagement with said first outer diameter of said first sun wheel, said first planet wheel held by said first planet carrier;
a first ring gear having an inner toothing in meshed engagement with said first planet wheel, said first ring gear having a first inner diameter;
first switching means for blocking and unblocking said first ring gear;
a second sun wheel, said second sun wheel having a second outer diameter which differs from said first outer diameter of said first sun wheel;
a second planet carrier;
a second planet wheel in meshed engagement with said second outer diameter of said second sun wheel, said second planet wheel held by said second planet carrier;
a second ring gear having an inner toothing in meshed engagement with said second planet wheel, said second ring gear having a second inner diameter which differs from said first diameter of said first ring gear; and
second switching means for blocking and unblocking said second planet carrier, wherein, said first planet carrier defines an output of the electric hard tool, said first and said second ring gears cooperating with each other such that they cannot rotate relative to each other, wherein, in a first switching stage, said first switching means blocks said first and said second ring gears and, in a second switching stage, said second switching means blocks said second planet carrier, at least one of said first and said second sun wheels being driven by the drive shaft.

2. The device of claim 1, wherein said first and said second sun wheels are coupled to each other such that they cannot rotate relative to each other.

3. The device of claim 1, wherein said first and said second switching means can be axially displaced into and out of engagement for switching said first and said second switching stages.

4. The device of claim 1, further comprising a housing defining an outer surface of the hand tool.

5. The device of claim 1, wherein said first and said second switching means are fixed to a switching ring.

6. The device of claim 1, wherein the hand tool is a screwdriver.
